(19) United States
(12) Patent Application Publication
(10) Pub. No.: US 2009/0105062 A1
(43) Pub. Date: Apr. 23, 2009

(54) Sintered Wear-Resistant Boride Material, Sinterable Powder Mixture, for Producing Said Material, Method for Producing the Material and Use Thereof

(75) Inventors: Hubert Thaler, Kempten (DE); Clemens Schmalzried, Pfronten (DE); Frank Wallmeier, Kempten (DE); Christoph Lesniak, Buchenberg (DE)

Correspondence Address: THE NATH LAW GROUP, 112 South West Street, Alexandria, VA, 22314, US

(73) Assignee: ESK CERAMICS GmbH & Co., KG, Kempten (DE)

(21) Appl. No.: 12/225,473

(22) PCT Filed: Mar. 12, 2007
(86) PCT No.: PCT/EP2007/002160

§ 371 Date: Oct. 7, 2008

(30) Foreign Application Priority Data
Mar. 24, 2006 (DE) 10 2006 013 746.9

(51) Int. Cl. C04B 35/58

(52) U.S. Cl. 501/96.3

(57) ABSTRACT

The invention relates to a sintered wear-resistant material which is based on transition metal diborides and comprises
a) as main phase, 80-98.8% by weight of a fine-grained transition metal diboride or transition metal diboride mixed crystal comprising at least two transition metal diborides or mixtures of such diboride mixed crystals or mixtures of such diboride mixed crystals with one or more transition metal diborides, where the transition metals are selected from sub-groups IV to VI of the Periodic Table,
b) as second phase, 0.2 to 5% by weight of a continuous, oxygen-containing grain boundary phase and
c) as third phase, 1-15% by weight of particulate boron carbide and/or silicon carbide.

The invention further relates to a pulverulent sinterable mixture for producing such a sintered material, process for producing the sintered material, preferably by pressureless sintering, and also the use of the sintered material for producing wear parts in general mechanical engineering, in particular chemical plant construction.

### FIELD OF THE INVENTION

The invention relates to a sintered wear-resistant material based on transition metal diborides, pulverulent sinterable mixtures for producing such a sintered material, processes for producing such sintered materials and the use of the sintered material for producing wear parts in general plant construction, in particular chemical plant construction, for producing tools for cutting machining and also for noncutting working and shaping, and also as electrode material for sliding contacts, welding electrodes and eroding pins.

### BACKGROUND OF THE INVENTION

Titanium diboride has a number of advantageous properties such as a high melting point of 3225° C., a high hardness of 26-32 GPa [HV], excellent electrical conductivity at room temperature and good chemical resistance.

A major disadvantage of titanium diboride is its poor sinterability. The poor sinterability is partly attributable to impurities, in particular oxygen impurities in the form of TiO₂ which are present in the titanium diboride powders usually used as a result of the method of production, either by carbothermic reduction of titanium oxide and boron oxide or by the reduction of metal oxides by means of carbon and/or boron carbide, known as the boron carbide process. Such oxygen impurities increase grain and pore growth during the sintering process by increasing surface diffusion.

### PRIOR ART

Sintered titanium diboride materials can be produced by the hot pressing process. For example, densities of over 95% of the theoretical density have been achieved by uniaxial hot pressing at sintering temperatures above 1800° C. and a pressure of >20 MPa, with the hot-pressed material typically having a grain size of more than 20 μm. However, the hot pressing process has the disadvantage that only simple body geometries can be produced thereby, while bodies or components having complex geometries cannot be produced by this process.

In contrast, components having more complex geometries can be produced by the pressureless sintering process. Here, it is necessary to add suitable sintering aids in order to obtain sintered bodies having a high density. Possible sintering additives are, for example, metals such as iron and iron alloys. Addition of small amounts of iron makes it possible to obtain dense materials having good mechanical properties and high fracture toughnesses of over 8 MPa m^{1/2}. Such materials are described, for example, in EP 433 856 B1. However, these materials having a metallic binder phase, which can also be referred to as cermets, have the disadvantage that they have poor corrosion resistance to air or oxygen because of the metallic binder phase and are, in particular, not resistant to acids and bases. Owing to their reactivity toward acids and bases, these materials cannot be used in chemical plant construction.

U.S. Pat. No. 5,108,670 describes a process for producing a sintered titanium diboride material which has improved toughness and does not contain a metallic binder phase. To produce the sintered material, titanium diboride is mixed with up to 10% by weight of chromium diboride, the mixture is pressed in a mold and is subsequently sintered in a powder bed composed of Y₂O₃ granules in a microwave oven, so that the Y₂O₃ then reacts with the TiB₂ and forms an yttrium-titanium oxide phase, resulting in a TiB₂ material having an oxidic second phase. Although a relatively high fracture toughness of about 6 MPa·m^{1/2} is achieved by this material, it has the disadvantage that a hardness of not more than 18 GPa is achieved, which is very low for wear applications. In addition, the process of sintering in a powder bed is unsuitable for the production of parts having a large volume and of parts having relatively thick walls since a homogeneous distribution cannot be achieved.

### OBJECT OF THE INVENTION

It is therefore an object of the invention to provide a sintered material which not only has good mechanical properties such as high hardness, high strength and high toughness but is also oxidation- and corrosion-resistant, in particular to acids and alkalis, and if required also has good mechanical properties at high temperatures. Such a sintered material should also be able to be produced by a simple and inexpensive process which also allows the manufacture of shaped bodies having complex geometries.

### SUMMARY OF THE INVENTION

The above object is achieved according to the invention by a sintered wear-resistant material based on transition metal diborides as claimed in claim 1, a pulverulent sinterable mixture for producing such a sintered material as claimed in claim 8, processes for producing such a sintered material as claimed in claims 15 and 16 and the use of the sintered material as claimed in claims 22-26. Advantageous or particularly useful embodiments of the subject matter of the application are described in the dependent claims.

The invention accordingly provides a sintered wear-resistant material which is based on transition metal diborides and comprises
a) as main phase, 80-98.8% by weight of a fine-grained transition metal diboride or transition metal diboride mixed crystal comprising at least two transition metal diborides or mixtures of such diboride mixed crystals or mixtures of such diboride mixed crystals with one or more transition metal diborides, where the transition metals are selected from sub-groups IV to VI of the Periodic Table,
b) as second phase, 0.2 to 5% by weight of a contiguous, oxygen-containing grain boundary phase and
c) as third phase, 1-15% by weight of particulate boron carbide and/or silicon carbide.

The invention further provides a pulverulent sinterable mixture for producing a sintered material based on transition metal diborides, which comprises
1) 0.05-2% by weight of Al and/or Si as metallic Al and/or Si and/or an amount of an Al and/or Si compound corresponding to this content,
2) optionally at least one component selected from among carbides and borides of transition metals of sub-groups IV to VI of the Periodic Table,
3) 0.5-19% by weight of boron,
4) 0-15% by weight of boron carbide and/or silicon carbide and
5) as balance, at least one transition metal diboride of sub-groups IV to VI of the Periodic Table which is different from the transition metal boride of component 2) above.

The invention further provides a process for producing such a sintered material by hot pressing or hot isostatic pressing or gas pressure sintering or spark plasma sintering of a pulverulent mixture as described above, if appropriate with addition of organic binders and pressing aids.

The invention likewise provides a process for producing a sintered material as described above by pressureless sintering, which comprises the steps:
a) mixing of a pulverulent mixture as described above, if appropriate with addition of organic binders and pressing aids, with water and/or organic solvents to produce a homogeneous powder suspension,
b) production of a granulated powder from the powder suspension,
c) pressing of the granulated powder to form green bodies having a high density and
d) pressureless sintering of the resulting green bodies under reduced pressure or under protective gas at a temperature of 1800-2200° C.

The sintered material of the invention is suitable for producing wear parts in general plant construction, in particular in chemical plant construction because of its corrosion resistance to acids and bases, in thermal plant construction, in paper machines, in milling technology and in wear protection.

The invention likewise provides for the use of the sintered material for producing tools for cutting machining and also for noncutting working and shaping, forming technology and for deflection rollers.

A further use relates to the production of water-blasting and sand-blasting nozzles.

The sintered material of the invention is likewise suitable as electrode material for sliding contacts, welding electrodes and eroding pins.

According to the invention, it has thus been shown that the abovementioned object is achieved by provision of a sintered, wear-resistant dense material which is based on transition metal diborides and whose matrix (main phase) comprises a fine-grained transition metal diboride or transition metal diboride mixed crystal or a combination thereof. As second phase, the material contains an oxygen-containing, continuous grain boundary phase which is in the form of a thin continuous grain boundary film. At the triple points, relatively large amounts or regions of the oxygen-containing second phase can be present. As third phase, the material contains particulate boron carbide and/or silicon carbide which acts as grain growth inhibitor. The mixed crystal formation of the main phase has an additional grain-growth-inhibiting effect, so that a sintered material having good mechanical properties is obtained. The sintered material of the invention has a surprisingly outstanding corrosion resistance to acids and alkalis while retaining very good mechanical properties.

### DETAILED DESCRIPTION OF THE INVENTION

As mentioned above, the microstructure of the material of the invention comprises the fine-grained main phase comprising a transition metal diboride or transition metal diboride mixed crystal of at least two transition metal diborides or mixtures of such diboride mixed crystals or mixtures of such diboride mixed crystals with one or more transition metal diborides. As second phase, a continuous oxygen-containing grain boundary film having a low thickness of, for example, about 2 nm is present. At the triple points, relatively large amounts or regions of the oxygen-containing second phase can be present. A small proportion of particulate boron carbide and/or silicon carbide, which is located predominantly at the grain boundaries, is present as third phase. The boron carbide and/or silicon carbide additionally have/has a particle-strengthening effect. If appropriate, small amounts of particulate carbon and/or particulate boron can also be present in the material. Furthermore, when Al or Si or compounds thereof are used as sintering aids, small amounts of these elements can be present in the main phase. The proportion of the oxygen-containing second phase is preferably up to 2.5% by weight.

The main phase preferably has an average grain size of less than 20 μm, more preferably less than 10 μm. The boron carbide and/or silicon carbide of the third phase preferably has an average particle size of less than 20 μm, more preferably less than 5 μm, and the proportion of this third phase is 1-15% by weight, preferably 1-4% by weight.

The average grain size of the main phase and the average particle size of the boron carbide and/or silicon carbide are determined by the linear intercept length method on an etched polished section.

The transition metals of sub-groups IV to VI are preferably selected from among Ti, Zr, Hf, V, Nb, Ta, Cr, Mo and W.

The main phase is preferably fine-grained TiB₂ and/or ZrB₂ and/or a mixed crystal of (TiW)B₂ and/or (Zr,W)B₂ and/or (Ti,Zr)B₂, more preferably a mixed crystal of (Ti,W)B₂ and/or (Zr,W)B₂, including the ternary diborides (Ti,Zr,W)B₂. The main phase is particularly preferably the mixed crystal (Ti,W)B₂ or the mixed crystal (Zr,W)B₂.

The pulverulent, sinterable mixture of the invention for producing a sinterable material according to the invention comprises the following components:

1) 0.05-2% by weight, preferably 0.2-0.6% by weight, of Al and/or Si as metallic Al and/or Si and/or an amount of an Al and/or Si compound corresponding to this content. Preference is given to using Al or oxygen-containing Al compounds, in particular Al₂O₃ or boehmite.
2) Optionally, preferably ≧0.25% by weight of at least one component selected from among carbides and borides of transition metals of sub-groups IV to VI of the Periodic Table, preferably tungsten carbide. If appropriate, transition metals of sub-groups IV to VI themselves and oxides of such transition metals can also be used as component 2).
3) 0.5-19% by weight, preferably 1-5% by weight, of boron in elemental form.
4) 0-15% by weight, preferably 0.5-5% by weight of boron carbide and/or silicon carbide.
5) As balance, at least one transition metal diboride of sub-groups IV to VI of the Periodic Table which is different from the transition metal boride of component 2) above. As mentioned above, the transition metals are selected from among Ti, Zr, Hf, V, Nb, Ta, Cr, Mo and W. The transition metal diboride of component 5) is preferably TiB₂ and/or ZrB₂, more preferably TiB₂.

The above components of the pulverulent mixture are preferably used in a very high purity and a small particle size. For example, the transition metal diboride of component 5) preferably has an average particle size of not more than 4 μm, more preferably not more than 2 μm.

The sintered material of the invention can be produced in a manner known per se by hot pressing, hot isostatic pressing, gas pressure sintering or spark plasma sintering of a pulverulent mixture as described above, if appropriate with addition of organic binders and pressing aids. Here, it is possible to use customary organic binders such as polyvinyl alcohol (PVA), water-soluble resins and polyacrylic acids and also customary pressing aids such as fatty acids and waxes.

To produce the sintered material of the invention, at least one transition metal diboride of sub-groups IV to VI is processed together with other pulverulent components and, if appropriate, organic binders and pressing aids in water and/or organic solvents to form a homogeneous powder suspension. The homogeneous powder suspension is then converted into a granulated powder, preferably by spray drying. This granulated powder can then be processed further by hot pressing or hot isostatic pressing to give a sintered material.

In a preferred embodiment, the sintered material of the invention is produced by pressureless sintering. Here, a granulated powder obtained as described above is pressed to form green bodies having a high density. All customary shaping processes such as uniaxial pressing or cold isostatic pressing and also extrusion, injection molding, slip casting and pressure slip casting can be used for this purpose. The green bodies obtained are then converted into a sintered material by pressureless sintering under reduced pressure or under protective gas at a temperature of 1800-2200° C., preferably 1900-2100° C., more preferably about 2000° C.

The green bodies are preferably baked in an inert atmosphere at temperatures below the sintering temperature in order to remove the organic binders or pressing aids before pressureless sintering.

The materials obtained by pressureless sintering have a density of at least about 94% of the theoretical density, preferably a density of at least 97% of the theoretical density. Such density values ensure that any porosity present is closed porosity. If desired, the sintered material can be after-densified by hot isostatic pressing to increase the density and to reduce the closed porosity.

The component of the pulverulent starting mixture which is selected from among carbides of transition metals of sub-groups IV to VI of the Periodic Table reacts with the added boron during the sintering process to form transition metal boride and boron carbide. The transition metal boride formed and/or the added transition metal boride of the abovementioned component 2) can form a mixed crystal with the transition metal diboride of component 5), for instance titanium diboride. This boride mixed crystal formation has a grain-growth-inhibiting effect. The boron carbide, both that added and that formed, for example, from tungsten carbide and boron, likewise has a grain-growth-inhibiting effect.

The Al and/or Si or their compounds act as sintering aids and the microstructure formed indicates a liquid-phase sintering process.

The sintered material of the invention is outstandingly suitable for producing wear parts in general plant construction, in particular chemical plant construction, thermal plant construction, in paper machines, in milling technology and in wear protection. Specific uses of the sintered material of the invention are tools for cutting machining and for noncutting working and shaping, for forming technology and for deflection rollers. It is also suitable for producing water-blasting or sand-blasting nozzles and also as electrode materials for sliding contacts, welding electrodes and eroding pins.

### BRIEF DESCRIPTION OF THE ACCOMPANYING DRAWINGS

FIG. 1 shows an optical photomicrograph of the microstructure of the material obtained in Example 1;

FIG. 2 shows an optical photomicrograph of the microstructure of the sintered material obtained in Example 2;

FIG. 3a shows a bright-field transmission electron micrograph of a representative region of the microstructure of FIG. 1;

FIGS. 3b and 3c show the EELS spectra corresponding to FIG. 3a which indicate the qualitative elemental composition of the examined region of the oxygen-containing secondary phase;

FIG. 4a shows a bright-field transmission electron micrograph of a representative (Ti,W)B₂—(Ti,W)B₂ grain boundary of a representative region of the microstructure of FIG. 1;

FIG. 4b shows the oxygen distribution corresponding to FIG. 4a determined by EFTEM (energy filtering transmission electron microscopy);

FIG. 4c shows the line scan of oxygen along the line drawn in FIG. 4b; and

FIG. 5 shows an optical photomicrograph of the microstructure of the sintered material obtained in Reference Example 1;

The following examples and Reference Example 1 illustrate the invention.

### EXAMPLE 1

450 g of TiB₂ powder (d₅₀=2 μm; 1.7% by weight of oxygen, 0.15% by weight of carbon, 0.077% by weight of Fe), 30 g of tungsten carbide (d50<1 μm), 10 g of amorphous boron (purity: 96.4%, d50<1 μm), 8 g of boron carbide powder (d50=0.7 μm) and 2 g of Al₂O₃ (boehmite as starting material) are dispersed together with 10 g of polyvinyl alcohol having an average molar mass of 1500 as binder and 20 g of stearic acid as pressing aid in aqueous solution and spray dried. The granular spray-dried material is uniaxially pressed at 1000 bar to give green bodies. The total oxygen content of a carbonized green body is 2.7%. The green bodies are heated under reduced pressure to 2020° C. at 10 K/min and maintained at the sintering temperature for 45 minutes. Cooling is carried out under Ar with the heating power switched off.

The sinter density of the samples obtained is 98% of the theoretical density.

An optical photomicrograph of the microstructure is shown in FIG. 1.

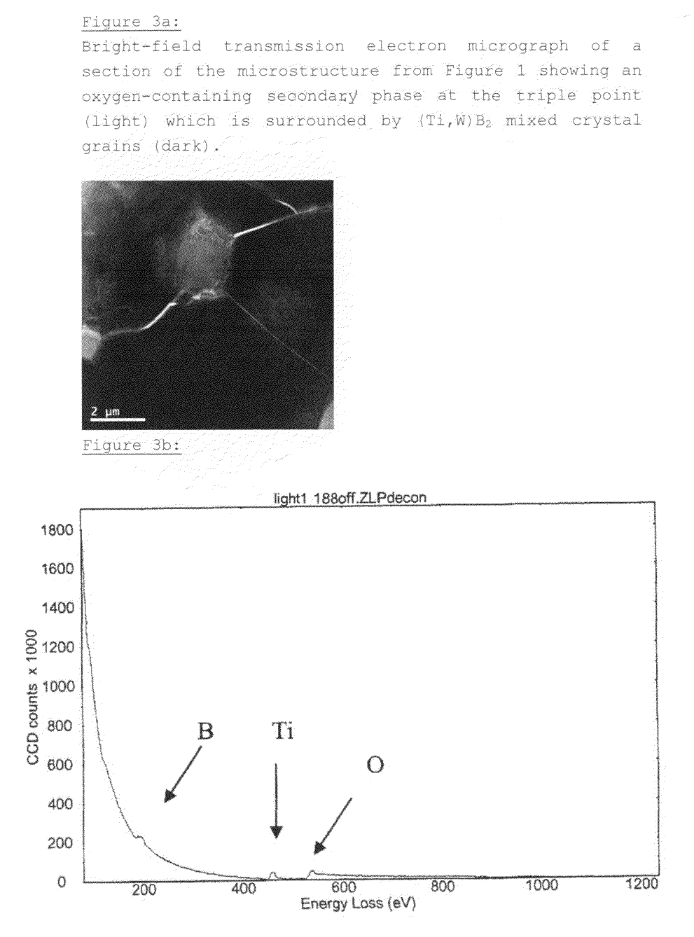

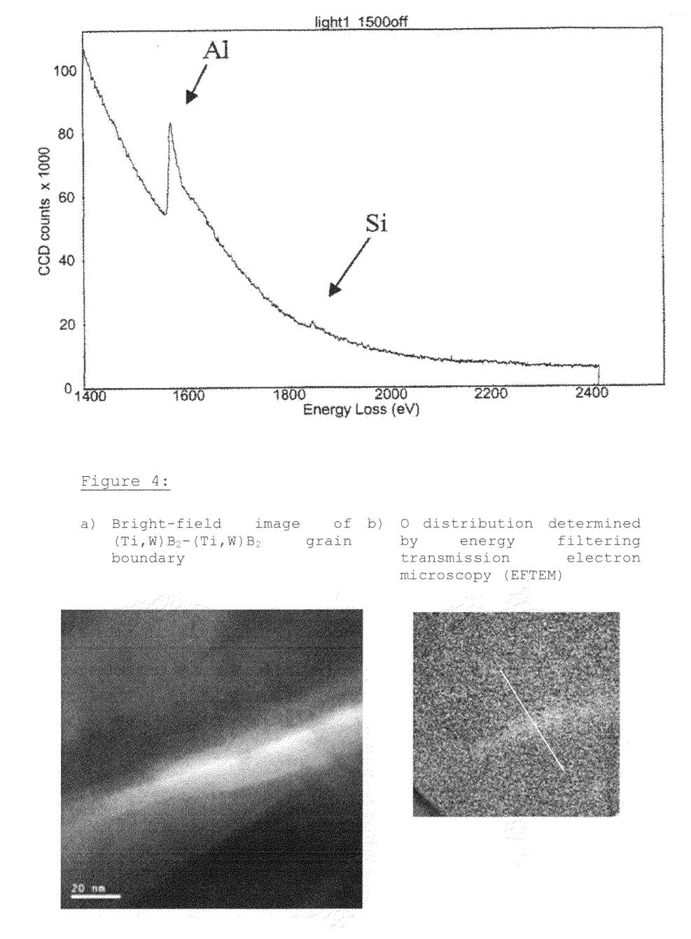

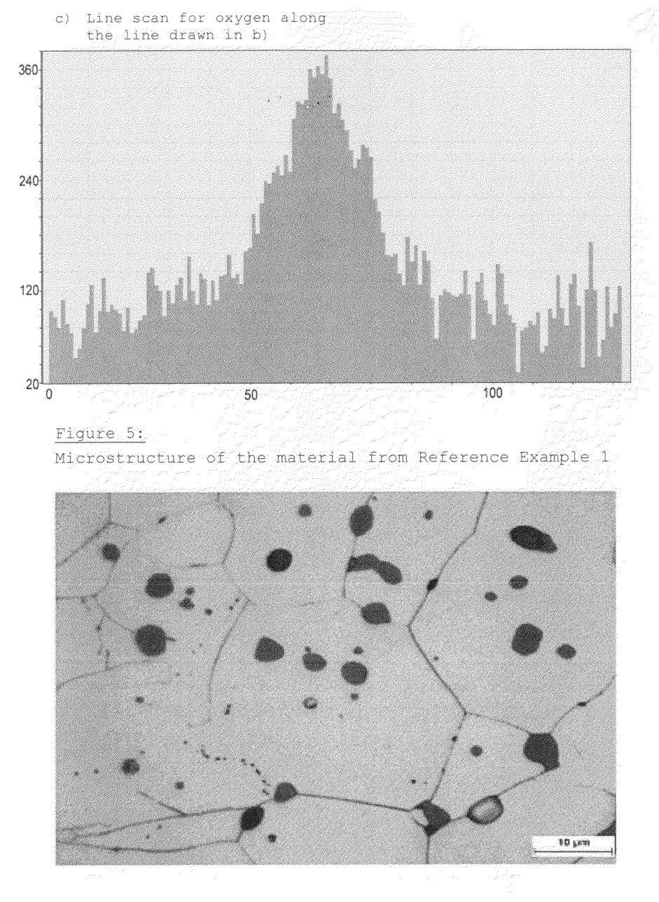

The resulting microstructure comprises a (Ti,W)B₂ mixed crystal matrix, finely divided particulate B₄C, a Ti—Al—B—O phase which is predominantly present at the triple points (FIGS. 3a, b and c, EELS spectroscopy) and an about 2 nm thick, continuous oxygen-containing amorphous grain boundary film (FIGS. 4a, b and c, EFTEM).

The hardness of the sintered body is 2500 (HKO.1), the fracture toughness was determined by the SEVNB method and is 5.3 MPa·m^{1/2}, the E modulus is 560 GPa and the flexural strength measured by the 4-point method is 500 MPa.

### EXAMPLE 2

450 g of TiB₂ powder (d₅₀=2 μm; 1.7% by weight of O, 0.15% by weight of C, 0.077% by weight of Fe), 30 g of WC (d50<1 μm), 10 g of amorphous boron (purity: 96.4%, d50<1 μm), 8 g of B₄C (d50=0.7 μm) and 2 g of Al₂O₃ (boehmite as starting material) are dispersed together with 10 g of polyvinyl alcohol having an average molar mass of 1500 as binder and 20 g of stearic acid as pressing aid in aqueous solution and spray dried. The granular spray-dried material is cold-isostatically pressed at 1200 bar to give green bodies. The total oxygen content of a carbonized green body is 2.7%. The green bodies are heated under reduced pressure to 2060° C. at 10 K/min, and maintained at the sintering temperature for 45 minutes. Cooling is carried out under Ar with the heating power switched off.

The sintered density of the specimens obtained is 98.7% of the theoretical density.

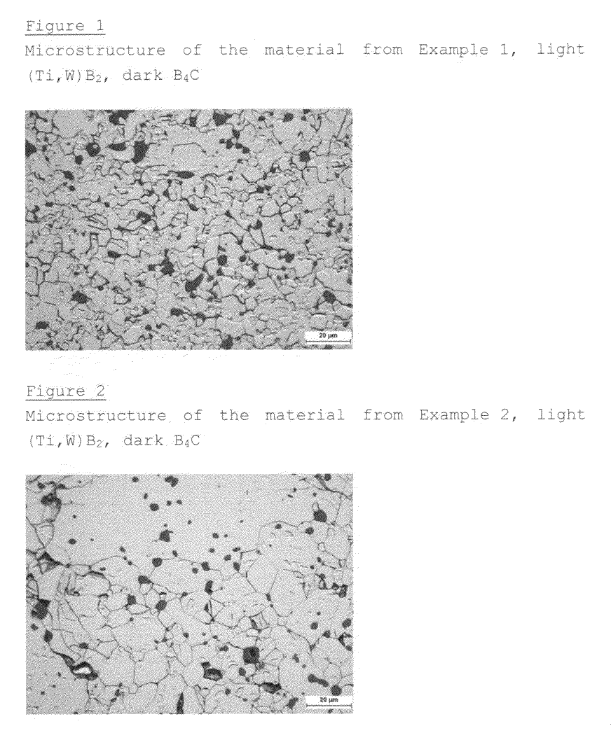

An optical photomicrograph of the microstructure is shown in FIG. 2.

The resulting microstructure comprises a (Ti,W)B₂ mixed crystal matrix, finely divided particulate B₄C, a Ti—Al—B—O phase which is predominantly present at the triple points and an about 2 nm thick, continuous oxygen-containing amorphous grain boundary film.

### EXAMPLE 3

436 g of TiB₂ powder (d₅₀=2 μm; 1.7% by weight of O, 0.15% by weight of C, 0.077% by weight of Fe), 44 g of WC (d50<1 μm), 18 g of amorphous boron (purity: 96.4%, d50<1 μm) and 2 g of Al₂O₃ (boehmite as starting material) are dispersed together with 10 g of polyvinyl alcohol having an average molar mass of 1500 as binder and 20 g of stearic acid as pressing aid in aqueous solution and spray dried. The granular spray-dried material is cold-isostatically pressed at 1200 bar to give green bodies. The green bodies are heated to 2020° C. at 10 K/min, and maintained at the sintering temperature for 45 minutes. Cooling is carried out under Ar with the heating power switched off.

### EXAMPLE 4

The sintered bodies from Example 1 are after-densified by hot isostatic pressing at 2000° C. and 1950 bar under argon with a hold time of 60 minutes. The density of the specimens obtained is 99.1% of the theoretical density.

Specimens of the materials produced as described in Example 4 were subjected to a corrosion test in 1 molar HCl at 100° C. The sample dimensions were 20×3×4 mm. The specimens were exposed to the corrosion medium for 90 minutes. After this time, the corrosion rate was 1.51 μg/mm²·h.

For comparison, this test was also carried out on reference specimens produced from a sintered TiB₂ material containing 0.5% by volume of an Fe—Cr—Ni binder phase. The corrosion rate determined there on specimens having the same dimensions as above was 5.26 μg/mm²·h, so that the material according to the invention from Example 4 had a corrosion rate which was reduced by a factor of 5.

### REFERENCE EXAMPLE 1

### Starting Mixture without Al Compound as Sintering Aid

450 g of TiB₂ powder (d₅₀=2 μm; 1.7% by weight of O, 0.15% by weight of C, 0.077% by weight of Fe), 30 g of WC (d50<1 μm) and 20 g of amorphous B (purity: 96.4%, d50<1 μm) are dispersed together with 10 g of polyvinyl alcohol having an average molar mass of 1500 as binder and 20 g of stearic acid as pressing aid in aqueous solution and spray dried. The granular spray-dried material is cold-isostatically pressed at 1200 bar to form green bodies. The green bodies are heated under reduced pressure to 2170° C. at 10 K/min and maintained at the sintering temperature for 45 minutes. Cooling is carried out under Ar with the heating power switched off. The sintered body is subsequently after-densified at 2000° C. under an Ar pressure of 1950 bar for one hour. The density is 97.9% of theoretical density.

An optical photomicrograph of the microstructure is shown in FIG. 5.

The resulting microstructure comprises a (Ti,W)B₂ mixed crystal matrix and particulate boron carbide which is partly present in the grain boundary and partly in the mixed crystal grains. The average grain diameter is about 100 μm. A higher sintering temperature was required here to achieve closed porosity. A coarse-grain microstructure results.

1. A sintered wear-resistant material which is based on transition metal diborides and comprises
a) as main phase, 80-98.8% by weight of a fine-grained transition metal diboride or transition metal diboride mixed crystal comprising at least two transition metal diborides or mixtures of such diboride mixed crystals or mixtures of such diboride mixed crystals with one or more transition metal diborides, where the transition metals are selected from sub-groups IV to VI of the Periodic Table,
b) as second phase, 0.2 to 5% by weight of a continuous, oxygen-containing grain boundary phase and
c) as third phase, 1-15% by weight of particulate boron carbide and/or silicon carbide.

2. The material as claimed in claim 1, wherein the main phase a) has an average grain size of less than 20 μm, preferably less than 10 μm.

3. The material as claimed in claim 1, wherein the boron carbide and/or silicon carbide of the third phase c) have/has an average particle size of less than 20 μm, preferably less than 5 μm.

4. The material as claimed in claim 1, wherein the proportion of the third phase c) is 1-4% by weight.

5. The material as claimed in claim 1, wherein the second phase b) is present in a proportion of up to 2.5% by weight.

6. The material as claimed in claim 1, wherein the transition metals of sub-groups IV to VI are selected from among Ti, Zr, Hf, V, Nb, Ta, Cr, Mo and W.

7. The material as claimed in claim 1, wherein the main phase a) is fine-grained TiB₂ and/or ZrB₂ and/or a mixed crystal of (TiW)B₂ and/or (Zr,W)B₂ and/or (Ti,Zr)B₂, preferably a mixed crystal of (Ti,W)B₂ and/or (Zr,W)B₂, more preferably the mixed crystal (Ti,W)B₂ or the mixed crystal (Zr,W)B₂.

8. A pulverulent sinterable mixture for producing a sintered material based on transition metal diborides, which comprises
1) 0.05-2% by weight of Al and/or Si as metallic Al and/or Si and/or an amount of an Al and/or Si compound corresponding to this content,
2) optionally at least one component selected from among carbides and borides of transition metals of sub-groups IV to VI of the Periodic Table,
3) 0.5-19% by weight, preferably 1-5% by weight of boron,
4) 0-15% by weight, preferably 0.5-5% by weight of boron carbide and/or silicon carbide and
5) as balance, at least one transition metal diboride of sub-groups IV to VI of the Periodic Table which is different from the transition metal boride of component 2) above.

9. The mixture as claimed in claim 8, wherein the proportion of component 1) is 0.2-0.6% by weight.

10. The mixture as claimed in claim 8, wherein the proportion of component 2) is ≧0.25% by weight.

11. The mixture as claimed in claim 8, wherein the transition metal diboride of the component 5) has an average particle size of ≦4 μm, preferably ≦2 μm.

12. The mixture as claimed in claim 8, wherein the transition metals of sub-groups IV to VI are selected from among Ti, Zr, Hf, V, Nb, Ta, Cr, Mo and W.

13. The mixture as claimed in claim 8, wherein component 2) is tungsten carbide.

14. The mixture as claimed in claim 8, wherein the transition metal diboride of component 5) is TiB₂ and/or ZrB₂.

15. A process for producing a sintered material as claimed in claim 1 by hot pressing or hot isostatic pressing or gas pressure sintering or spark plasma sintering of a pulverulent mixture as claimed in at least one of claims 8-14, if appropriate with addition of organic binders and pressing aids.

16. A process for producing a sintered material as claimed in claim 1 by pressureless sintering, which comprises the steps:
a) mixing of a pulverulent mixture as claimed in at least one of claims 9-14, if appropriate with addition of organic binders and pressing aids, with water and/or organic solvents to produce a homogeneous powder suspension,
b) production of a granulated powder from the powder suspension,
c) pressing of the granulated powder to form green bodies having a high density and
d) pressureless sintering of the resulting green bodies under reduced pressure or under protective gas at a temperature of 1800-2200° C.

17. The process as claimed in claim 16, wherein the production of the granulated powder in step b) is carried out by spray drying.

18. The process as claimed in claim 16, wherein the production of the green bodies in step c) is carried out by uniaxial pressing, cold isostatic pressing, extrusion, injection molding, slip casting or pressure slip casting.

19. The process as claimed in claim 16, wherein the green bodies obtained in step c) are baked in an inert atmosphere at temperatures below the sintering temperature before pressureless sintering.

20. The process as claimed in claim 16, wherein the pressureless sintering in step d) is carried out at a temperature in the range 1900-2100° C., preferably about 2000° C.

21. The process as claimed in claim 16, wherein the material which has been produced by pressureless sintering is after-densified by hot isostatic pressing.

22. The use of the sintered material as claimed in claim 1 for producing wear parts in general plant construction, in particular chemical plant construction, thermal plant construction, in paper machines, in milling technology and in wear protection.

23. The use of the sintered material as claimed in claim 1 for producing tools for cutting machining.

24. The use of the sintered material as claimed in claim 1 for producing tools for noncutting working and shaping, forming technology and for deflection rollers.

25. The use of the sintered material as claimed in claim 1 for producing water-blasting or sand-blasting nozzles.

26. The use of the sintered material as claimed in claim 1 as electrode material for sliding contacts, welding electrodes and
